(19) United States
(12) Patent Application Publication
(10) Pub. No.: US 2019/0274357 A1
(43) Pub. Date: Sep. 12, 2019

(54) CERAMIC HEATING ELEMENT WITH MULTIPLE TEMPERATURE ZONES

(71) Applicant: Key Material Co., Ltd., Dongguan City (CN)

(72) Inventor: Guoming LI, Lixi Town (CN)

(21) Appl. No.: 16/000,702

(22) Filed: Jun. 5, 2018

(30) Foreign Application Priority Data
Mar. 7, 2018 (CN) 201820314163.0

(51) Int. Cl. A24F 47/00; F28F 21/04

(52) U.S. Cl. CPC A24F 47/008; H05B 3/141; F28F 21/04

(57) ABSTRACT

The utility model discloses a ceramic heating element with multiple temperature zones, which comprises a ceramic heating element. The ceramic heating element consists of a first ceramic substrate, a second ceramic substrate, a heating circuit, an electrode pad, a heating temperature zone, an independent electrode lead and a common electrode, the first ceramic substrate and the second ceramic substrate are stacked and rolled to form a cylindrical or elliptic structure with a center hole, the heating circuit is printed on a front face of the second ceramic substrate, a plurality of electrode pads are printed on a back face of the second ceramic substrate, and a plurality of through holes are machined on an upper surface of the second ceramic substrate. The utility model has the beneficial effects of a simple structure and strong practicability.

### FIELD OF THE INVENTION

The utility model relates to the field of ceramic heating elements, and in particular to a ceramic heating element with multiple temperature zones.

### BACKGROUND OF THE INVENTION

E-cigarettes which are also known as electronic cigarettes are mainly used to quit smoking and replace cigarettes. Moreover, an e-cigarette heating element is an important part of an e-cigarette. A traditional e-cigarette heating element has two kinds of heating units, one of which is a heating wire, but the heating wire is located at an air vent of the heating element and its material is not corrosion-resistant such that the heating wire becomes a consumable part, and another structure of the heating element consists of an inner core (i.e. a blank), an outer layer and a substrate for clamping a heating wire such that the heating element has a relatively thick overall structure, a slow heating rate and poor heating effects, and its long-term use can cause the fracture of the inner core and the substrate, thus greatly shortening the service life. However, with the development of industrial technologies, ceramic heating elements are more and more widely applied to the field of e-cigarette heating elements and gradually replacing traditional e-cigarette heating elements due to their advantages of cleanliness, harmlessness, acid resistance, alkali resistance, high temperature resistance and a high heating rate.

Chinese Patent Document CN 204334973 U discloses a heating element for an e-cigarette, wherein a heating circuit is printed on a superimposed surface between two ceramic substrates to prevent the heating circuit from contacting the outside air and being oxidized by the outside air such that the heating circuit can still maintain a good heating effect for a long time. However, in the above patent, the ceramic heating element is not heated based on temperature zones, and therefore cannot be heated by stages.

With the development of science and technology and the progress of society, people have gradually increasing requirements on material life, and more and more people choose to quit smoking for their health. There are a variety of ways to quit smoking, in which e-cigarettes are very popular with people, but traditional e-cigarettes internally comprise heating elements with complex mounting structures and have a relatively short service life, and therefore have higher cost after their long-term use. However, ceramic heating elements can overcome the disadvantages of traditional heating elements, but existing ceramic heating elements cannot achieve multi-temperature zone heating. Accordingly, it is necessary to design a ceramic heating element with multiple temperature zones so as to solve the above problems.

### SUMMARY OF THE INVENTION

An object of the utility model is to provide a ceramic heating element with multiple temperature zones so as to solve the above problems.

To achieve the above object, the utility model employs the following technical solution: a ceramic heating element with multiple temperature zones comprises a ceramic heating element, wherein the ceramic heating element consists of a first ceramic substrate, a second ceramic substrate, a heating circuit, electrode pad, a heating temperature zone, an independent electrode lead and a common electrode, the first ceramic substrate and the second ceramic substrate are stacked and rolled to form a cylindrical or elliptic structure with a center hole, the heating circuit is printed on a front face of the second ceramic substrate, a plurality of electrode pads are printed on a back face of the second ceramic substrate, a plurality of through holes are machined on an upper surface of the second ceramic substrate, the electrode pads are connected with the heating circuit via the through holes, the heating circuit is divided into a plurality of heating temperature zones, and each of the heating temperature zones is internally correspondingly provided with two independent electrode leads or one independent electrode lead and one common electrode.

The ceramic heating element has a hollow cylindrical shape or a ceramic sheet inside.

The independent electrode lead and the common electrode are respectively communicated with the corresponding electrode pads.

The electrode pads are welded with metal leads by a brazing method.

The ceramic heating element is cylindrical or elliptic cylindrical.

Both of the first ceramic substrate and the second ceramic substrate are forming by a casting process.

The ceramic heating element with multiple temperature zones manufactured by the technical solution of the utility model has the advantages of simple operation, low manufacturing cost, use of a ceramic heating element which can be conveniently mounted and has a fast heating rate and a long service life, and adoption of multi-temperature zone heating which can achieve zone-based heating, thus being suitable for popularization and use.

### BRIEF DESCRIPTION OF THE DRAWINGS

FIG. 1 is a schematic structural view of a ceramic heating element with multiple temperature zones according to the utility model;

FIG. 2 is a schematic view of rolled ceramic substrates of the ceramic heating element with multiple temperature zones according to the utility model;

FIG. 3 is a schematic view of a front face of a second ceramic substrate of the ceramic heating element with multiple temperature zones according to the utility model; and

FIG. 4 is a schematic view of a back face of the second ceramic substrate of the ceramic heating element with multiple temperature zones according to the utility model.

In the Figures: 1. first ceramic substrate; 2. second ceramic substrate; 3. heating circuit; 4. electrode pad; 5. heating temperature zone; 6. independent electrode lead; 7. common electrode; 8. ceramic sheet; 9. ceramic heating element.

### DETAILED DESCRIPTION OF THE INVENTION

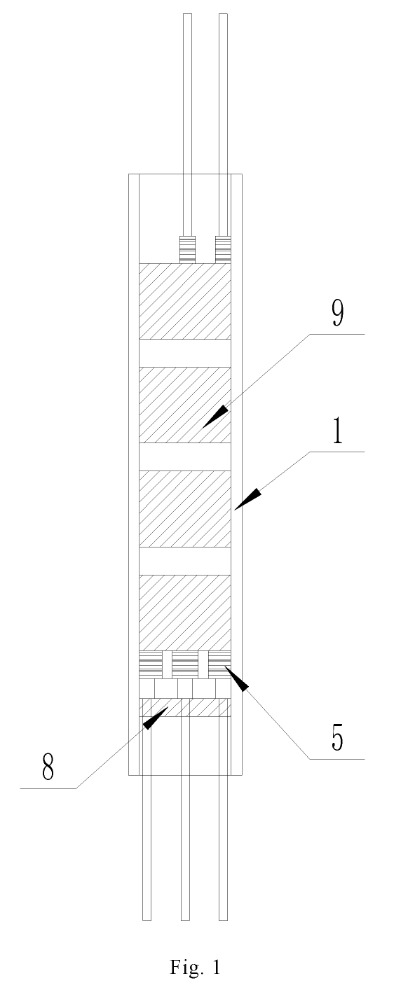

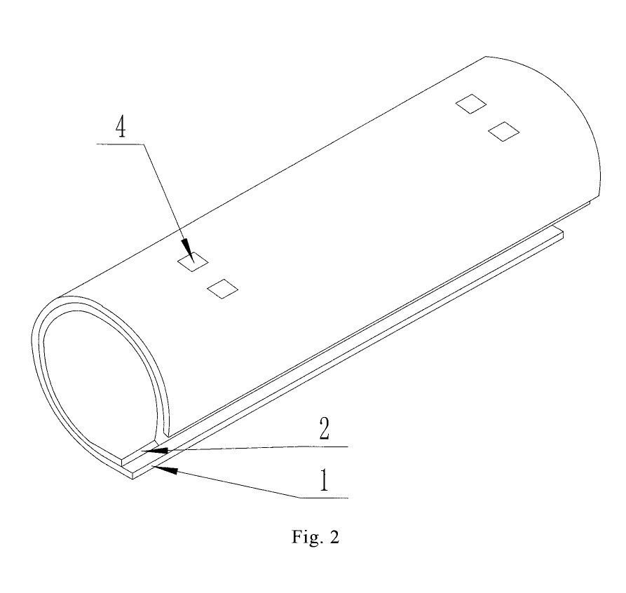

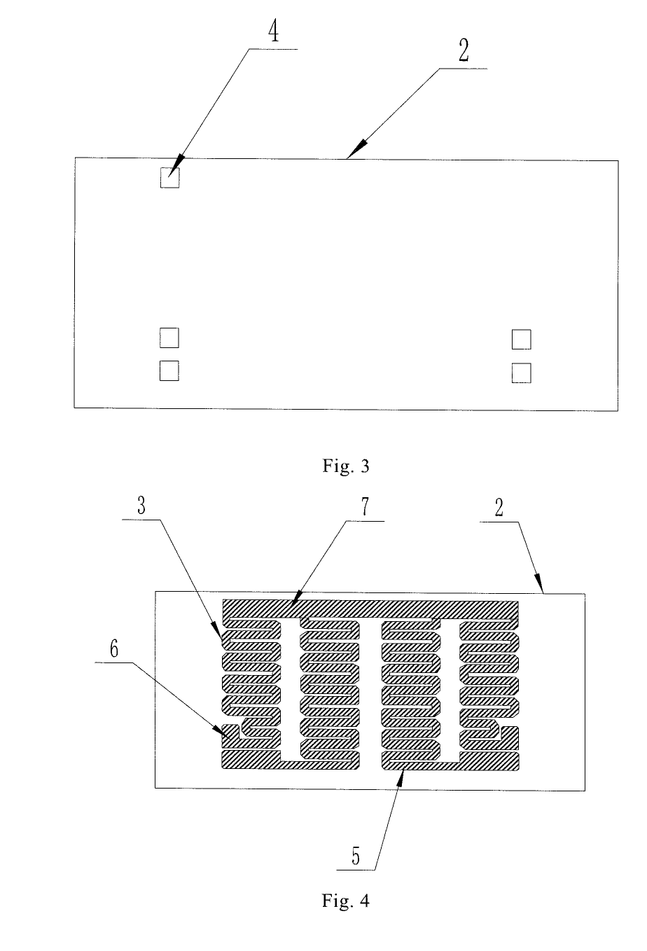

The utility model will be specifically described below with reference to the drawings. As shown in FIGS. 1 to 4, a ceramic heating element with multiple temperature zones comprises a ceramic heating element 9, wherein the ceramic heating element 9 consists of a first ceramic substrate 1, a second ceramic substrate 2, a heating circuit 3, an electrode pad 4, a heating temperature zone 5, an independent electrode lead 6 and a common electrode 7, the first ceramic substrate 1 and the second ceramic substrate 2 are stacked and rolled to form a cylindrical or elliptic structure with a center hole, the heating circuit 3 is printed on a front face of the second ceramic substrate 2, a plurality of electrode pads 4 are printed on a back face of the second ceramic substrate 2, a plurality of through holes are machined on an upper surface of the second ceramic substrate 2, the electrode pads 4 are connected with the heating circuit 3 via the through holes, the heating circuit 3 is divided into a plurality of heating temperature zones 5, and each of the heating temperature zones 5 is internally correspondingly provided with two independent electrode leads 6 or one independent electrode lead 6 and one common electrode 7; the ceramic heating element has a hollow cylindrical shape or a ceramic sheet 8 inside; the independent electrode lead 6 and the common electrode 7 are respectively communicated with the corresponding electrode pads 4; the electrode pads 4 are welded with metal leads by a brazing method; the ceramic heating element is cylindrical or elliptic cylindrical; and both of the first ceramic substrate 1 and second ceramic substrate 2 are formed by a casting process.

This embodiment is characterized in that: the ceramic heating element 9 consists of a first ceramic substrate 1, a second ceramic substrate 2, a heating circuit 3, an electrode pad 4, a heating temperature zone 5, an independent electrode lead 6 and a common electrode 7, the first ceramic substrate 1 and the second ceramic substrate 2 are stacked and rolled to form a cylindrical or elliptic structure with a center hole, the heating circuit 3 is printed on a front face of the second ceramic substrate 2, a plurality of electrode pads 4 are printed on a back face of the second ceramic substrate 2, a plurality of through holes are machined on an upper surface of the second ceramic substrate 2, the electrode pads 4 are connected with the heating circuit 3 via the through holes, the heating circuit 3 is divided into a plurality of heating temperature zones 5, and each of the heating temperature zones 5 is internally correspondingly provided with two independent electrode leads 6 or one independent electrode lead 6 and one common electrode 7. The ceramic heating element with multiple temperature zones has the advantages of simple operation, low manufacturing cost, use of a ceramic heating element which can be conveniently mounted and has a fast heating rate and a long service life, and adoption of multi-temperature zone heating which can achieve zone-based heating, thus being suitable for popularization and use.

In this embodiment, firstly, the utility model provides a ceramic heating element with multiple temperature zones, which comprises a ceramic heating element 9. The ceramic heating element 9 consists of a first ceramic substrate 1, a second ceramic substrate 2, a heating circuit 3, an electrode pad 4, a heating temperature zone 5, an independent electrode lead 6 and a common electrode 7. In particular, the first ceramic substrate 1 and the second ceramic substrate 2 are stacked and rolled to form a cylindrical or elliptic structure with a center hole, the heating circuit 3 is printed on a front face of the second ceramic substrate 23 while a plurality of electrode pads 4 are printed on a back face of the second ceramic substrate 2, and then a plurality of through holes are machined on an upper surface of the second ceramic substrate 2, wherein the electrode pads 4 are connected with the heating circuit 3 via the through holes. The heating circuit 3 is then divided into a plurality of heating temperature zones 5, and each of the heating temperature zones 5 is internally correspondingly provided with two independent electrode leads 6 or one independent electrode lead 6 and one common electrode 7. Subsequently, either a hollow cylindrical shape is machined or a ceramic sheet 8 is placed inside the ceramic heating element. In the present device, the independent electrode lead 6 and the common electrode 7 are respectively communicated with the corresponding electrode pads 4. In particular, the electrode pads 4 are welded with metal leads by a brazing method. The ceramic heating element is cylindrical or elliptic cylindrical. Both of the first ceramic substrate 1 and the second ceramic substrate 2 are formed by a casting process and made of one of alumina, aluminum nitride, silicon nitride and zirconium oxide or a combination thereof. In particular, the thickness of the first ceramic substrate 1 and the second ceramic substrate 2 is maintained at 0.1-0.6 MM.

The above technical solution merely represent a preferred technical solution of the utility model, and some possible changes made to certain parts therein by those skilled in the art embody the principles of the utility model and belong to the protection scope of the utility model.

1. A ceramic heating element with multiple temperature zones, comprising a ceramic heating element, the ceramic heating element consisting of a first ceramic substrate, a second ceramic substrate, a heating circuit, an electrode pad, a heating temperature zone, an independent electrode lead and a common electrode, the first ceramic substrate and the second ceramic substrate being stacked and rolled to form a cylindrical or elliptic structure with a center hole, the heating circuit being printed on a front face of the second ceramic substrate, a plurality of electrode pads being printed on a back face of the second ceramic substrate, a plurality of through holes being machined on an upper surface of the second ceramic substrate, the electrode pads being connected with the heating circuit via the through holes, the heating circuit being divided into a plurality of heating temperature zones, and each of the heating temperature zones being internally correspondingly provided with two independent electrode leads or one independent electrode lead and one common electrode.

2. The ceramic heating element with multiple temperature zones according to claim 1, wherein the ceramic heating element has a hollow cylindrical shape or a ceramic sheet inside.

3. The ceramic heating element with multiple temperature zones according to claim 1, wherein the independent electrode lead and the common electrode are respectively communicated with the corresponding electrode pads.

4. The ceramic heating element with multiple temperature zones according to claim 1, wherein the electrode pads are welded with metal leads by a brazing method.

5. The ceramic heating element with multiple temperature zones according to claim 1, wherein the ceramic heating element is cylindrical or elliptic cylindrical.

6. The ceramic heating element with multiple temperature zones according to claim 1, wherein both of the first ceramic substrate and the second ceramic substrate are formed by a casting process.
